(19) United States
(12) Patent Application Publication
(10) Pub. No.: US 2026/0029753 A1
(43) Pub. Date: Jan. 29, 2026

(54) WEARABLE DEVICE

(71) Applicant: Huawei Technologies Co., Ltd., Shenzhen (CN)

(72) Inventors: Shifeng Fu, Xi'an (CN); Xiaogang Liu, Xi'an (CN); Rui Sun, Xi'an (CN); Shuai Xu, Shenzhen (CN)

(21) Appl. No.: 18/995,104

(22) PCT Filed: Jul. 14, 2023
(86) PCT No.: PCT/CN2023/107467

§ 371 Date: Jan. 15, 2025

(30) Foreign Application Priority Data
Jul. 21, 2022 (CN) 202221887757.3

(51) Int. Cl. G04B 37/05; G04B 37/18; G04G 17/08

(52) U.S. Cl. CPC G04B 37/057; G04B 37/18; G04G 17/08

(57) ABSTRACT

Embodiments of this application relate to the field of terminal device technologies, and specifically, to a wearable device. According to the wearable device provided in embodiments of this application, an outer frame is provided with a mounting channel, and the mounting channel penetrates the outer frame. A housing is disposed in the mounting channel, and the housing is detachably connected to the outer frame. A movement is disposed in the housing.

### CROSS-REFERENCE TO RELATED APPLICATIONS

This application is a national stage of International Application No. PCT/CN2023/107467, filed on Jul. 14, 2023, which claims priority to Chinese Patent Application No. 202221887757.3, filed on Jul. 21, 2022. Both of the aforementioned applications are incorporated herein by reference in their entireties.

### TECHNICAL FIELD

Embodiments of this application relate to the field of terminal device technologies, and specifically, to a wearable device.

### BACKGROUND

With the gradual development of smart device technologies, smart watches are gradually widely used. A smart watch generally includes a housing, a movement, and a rear cover. The housing encloses a mounting channel having an opening at the bottom. The movement is mounted in the mounting channel. The rear cover is mounted at the bottom of the housing and seals the opening, to fasten the movement to the housing. However, when the housing is damaged, the rear cover needs to be opened, and each part of the movement needs to be taken out and mounted to a new housing. Consequently, there is great difficulty in repairing the smart watch.

### SUMMARY

Embodiments of this application provide a wearable device, to resolve a problem that there is great difficulty in repairing the wearable device.

The wearable device provided in embodiments of this application includes an outer frame and a housing mounted to the outer frame. The outer frame is provided with a mounting channel, and the mounting channel penetrates the outer frame. The housing is disposed in the mounting channel, and the housing is detachably connected to the outer frame. A movement is disposed in the housing, and the movement is configured to perform timekeeping.

Based on the foregoing disposition, the outer frame is provided with the mounting channel, and the mounting channel penetrates the outer frame. The housing is disposed in the mounting channel, and the housing is detachably connected to the outer frame. When the outer frame is damaged, because each part of the movement is disposed in the housing, the housing can be detached from the outer frame and mounted to a new outer frame without disassembling the movement. This reduces difficulty in repairing the wearable device.

In some embodiments that may include the foregoing embodiments, the wearable device includes a clamping component. The clamping component is disposed between the outer frame and the housing, and the outer frame is clamped to the housing by using the clamping component. Based on the foregoing disposition, the outer frame is clamped to the housing by using the clamping component. This facilitates detachment of the housing from the outer frame and mounting of the housing to the outer frame.

In some embodiments that may include the foregoing embodiments, the clamping component includes a clamping portion disposed on a side wall of the mounting channel. A clamping groove is provided on a side wall of the housing. The clamping portion is clamped in the clamping groove. Based on the foregoing disposition, the clamping component has a simple structure and is easy to manufacture.

In some embodiments that may include the foregoing embodiments, the clamping portion includes an elastic plate. The elastic plate is disposed on the side wall of the mounting channel. A protruding portion is provided on a surface that is of the elastic plate and that faces a center line of the mounting channel. The protruding portion is clamped in the clamping groove. Based on the foregoing disposition, the elastic plate has a specific elastic force. Under the action of the elastic force, the elastic plate is always clamped in the clamping groove. This prevents the clamping portion and the clamping groove from being separated during use. The clamping portion has a simple structure and is easy to manufacture.

In some embodiments that may include the foregoing embodiments, the clamping portion includes a first connection plate and a second connection plate. Both the first connection plate and the second connection plate are perpendicular to the center line of the mounting channel, and the first connection plate and the second connection plate are disposed at an interval along a direction parallel to the center line of the mounting channel. One end of the first connection plate is connected to the side wall of the mounting channel, and the other end of the first connection plate is connected to one end of the elastic plate. One end of the second connection plate is connected to the side wall of the mounting channel, and the other end of the second connection plate is connected to the other end of the elastic plate. Based on the foregoing disposition, a connection force between the elastic plate and the outer frame can be improved. This prevents the elastic plate from falling.

In some embodiments that may include the foregoing embodiments, the elastic plate, the first connection plate, and the second connection plate are of an integrated structure. The integrated structure is formed through a process such as bending, injection molding, or casting, so that the elastic plate does not need to be mounted on the first connection plate and the second connection plate again. This simplifies manufacturing difficulty. In addition, the first connection plate and the second connection plate are also elastic, so that a clamping force for the protruding portion to be clamped in the clamping groove can be improved, to further prevent the protruding portion and the clamping groove from being separated.

In some embodiments that may include the foregoing embodiments, the elastic plate may be a thermoplastic polyurethane (thermoplastic polyurethanes, TPU for short) elastomer plate. The elastic plate made of TPU may prevent the housing from being scratched while ensuring sufficient elasticity, to improve a service life of the wearable device.

In some embodiments that may include the foregoing embodiments, the elastic plate includes a first inclined plate and a second inclined plate that are sequentially disposed along a direction of the center line of the mounting channel. An end that is of the first inclined plate and that faces the second inclined plate is connected to the second inclined plate. The protruding portion is formed at a joint between the first inclined plate and the second inclined plate. The first inclined plate is disposed in an inclined manner relative to the center line of the mounting channel, so that an end that is of the first inclined plate and that is away from the second inclined plate is farther away from the center line of the mounting channel than the end that is of the first inclined plate and that faces the second inclined plate. The second inclined plate is disposed in an inclined manner relative to the center line of the mounting channel, so that an end that is of the second inclined plate and that is away from the first inclined plate is farther away from the center line of the mounting channel than an end that is of the second inclined plate and that faces the first inclined plate.

Based on the foregoing disposition, in a process of mounting the housing in the mounting channel, a side wall that is of the housing and that faces the mounting channel is first in contact with the second inclined plate, and the second inclined plate may guide the housing to move in the mounting channel. In addition, in a moving process of the mounting channel, the second inclined plate and the first inclined plate are gradually compressed and elastically deformed, to generate elastic forces. When the housing moves to a junction of the first inclined plate and the second inclined plate and is clamped in the clamping groove, under the action of the elastic forces of the first inclined plate and the second inclined plate, the junction of the first inclined plate and the second inclined plate is always clamped in the clamping groove, to connect the housing and the outer frame. Both the first inclined plate and the second inclined plate are elastically deformed, so that an elastic force of the elastic plate can be improved. This improves a connection force between the housing and the outer frame. When detaching the housing, a user may press the housing from an observation opening to a detachment opening, so that the junction of the first inclined plate and the second inclined plate gradually detaches from the clamping groove. After detachment, the housing gradually detaches from the mounting channel under guidance of the second inclined plate.

In some embodiments that may include the foregoing embodiments, the clamping component further includes an adapter plate. The elastic plate is disposed on the adapter plate. The adapter plate is connected to the side wall of the mounting channel. Based on the foregoing disposition, the elastic plate is connected to the side wall of the mounting channel by using the adapter plate. This facilitates mounting of the elastic plate.

In some embodiments that may include the foregoing embodiments, a mounting groove is provided on the side wall of the mounting channel, and the adapter plate is mounted in the mounting groove. Based on the foregoing disposition, the adapter plate can be prevented from protruding from the side wall of the mounting channel. This prevents the elastic plate from extending to the center line of the mounting channel for an excessively large distance, reduces a gap between the housing and the side wall of the mounting channel, and improves decoration effect of the wearable device.

In some embodiments that may include the foregoing embodiments, a groove bottom of the mounting groove is provided with a first bump. A first groove is provided on a surface that is of the adapter plate and that faces the groove bottom. The first bump is clamped in the first groove. Based on the foregoing disposition, the first bump is clamped in the first groove, so that positions of the adapter plate and the outer frame can be determined, and the adapter plate can also be prevented from shaking in the mounting groove during use.

In some embodiments that may include the foregoing embodiments, the first bump is provided with a second groove. A depth direction of the second groove is parallel to the center line of the mounting channel. A second bump is provided on a groove wall that is of the first groove and that is adjacent to the groove bottom. When the adapter plate is mounted in the mounting groove, the first bump is clamped in the first groove. In addition, the second bump is clamped in the second groove. Based on the foregoing disposition, position precision of the adapter plate and position precision of the outer frame are improved, and the adapter plate can be further prevented from shaking in the mounting groove during use.

In some embodiments that may include the foregoing embodiments, the wearable device further includes a fastening plate. The fastening plate covers a surface that is of the adapter plate and that is away from the side wall of the mounting channel. In other words, the fastening plate covers a surface that is of the adapter plate and that faces the center line of the mounting channel. The fastening plate is provided with a first through hole. The elastic plate extends out of the first through hole. The fastening plate is connected to the outer frame. The adapter plate is fastened to the outer frame by using the fastening plate, to fasten the elastic plate.

In some embodiments that may include the foregoing embodiments, the wearable device further includes a bonding layer. The bonding layer is disposed between the fastening plate and the adapter plate. The bonding layer is bonded to both the fastening plate and the adapter plate. Based on the foregoing disposition, a connection force between the adapter plate and the fastening plate can be improved, to further prevent the adapter plate from shaking in the mounting groove during use.

In some embodiments that may include the foregoing embodiments, the bonding layer is provided with a second through hole. The elastic plate extends out of the second through hole. An edge of the bonding layer is provided with a first foolproof groove. An end of the adapter plate is provided with a second foolproof groove. Projections of the first foolproof groove and the second foolproof groove on the side wall of the mounting channel overlap. Based on the foregoing disposition, foolproof between the bonding layer and the adapter plate can be implemented by using the first foolproof groove and the second foolproof groove. This facilitates mounting of the bonding layer.

In some embodiments that may include the foregoing embodiments, the groove bottom of the mounting groove is provided with a fastening post. The fastening plate is provided with a fastening hole. The fastening post is disposed to pass through the fastening hole. A stop portion is provided at an end that is of a fastening portion and that is away from the mounting channel. The stop portion abuts against a surface that is of the fastening plate and that faces the center line of the mounting channel. In this way, the stop portion can prevent the fastening plate and the fastening post from being separated, so that the fastening plate is fastened.

In some embodiments that may include the foregoing embodiments, the fastening plate is accommodated in the mounting groove, to prevent an excessively large distance between the housing and the mounting channel. This improves the decoration effect of the wearable device.

In some embodiments that may include the foregoing embodiments, a crown tube that communicates with internal space of the housing is provided on the housing. A matching groove is provided at an end of the outer frame. The matching groove penetrates the outer frame along a direction perpendicular to the center line of the mounting channel. Based on the foregoing disposition, when the housing is mounted in the mounting channel, the crown tube is clamped in the matching groove. The crown tube is clamped in the matching groove, so that positions of the housing and the outer frame can be limited, and the housing can be prevented from rotating in the mounting channel.

### BRIEF DESCRIPTION OF THE DRAWINGS

FIG. 1 is a diagram of assembly of a wearable device according to an embodiment of this application;

FIG. 2 is an exploded view 1 of a wearable device according to an embodiment of this application;

FIG. 3 is an exploded view 1 of an outer frame and a housing of a wearable device according to an embodiment of this application;

FIG. 4 is a schematic diagram of a structure of the outer frame in FIG. 3;

FIG. 5 is a partial enlargement diagram of A in FIG. 4;

FIG. 6 is a schematic diagram of a structure of the housing in FIG. 3;

FIG. 7 is a schematic diagram of a structure of a housing of a wearable device according to an embodiment of this application;

FIG. 8 is an exploded view 2 of a wearable device according to an embodiment of this application;

FIG. 9 is a schematic diagram of a structure of a clamping component in FIG. 3;

FIG. 10 is an exploded view 1 of a clamping component and an outer frame of a wearable device according to an embodiment of this application;

FIG. 11 is an exploded view of the clamping component, a bonding layer, and a fastening plate in FIG. 10;

FIG. 12 is an exploded view 2 of an outer frame and a housing of a wearable device according to an embodiment of this application;

FIG. 13 is a partial enlargement view of B in FIG. 12;

FIG. 14 is a schematic diagram of a structure, in which a stop portion abuts against a fastening plate, that is of a wearable device according to an embodiment of this application;

FIG. 15 is an exploded view 2 of a clamping component and an outer frame of a wearable device according to an embodiment of this application; and

FIG. 16 is an exploded view of the clamping component, a bonding layer, and a fastening plate in FIG. 15.

### DESCRIPTIONS OF REFERENCE NUMERALS

1: outer frame;
3: first watch strap;
4: second watch strap;
5: clamping component;
11: mounting channel;
12: matching groove;
13: stop flange;
51: clamping portion;
53: adapter plate;
54: fastening plate;
55: bonding layer;
100: wearable device;
101: observation opening;
102: detachment opening;
103: mounting groove;
104: first bump;
105: second groove;
106: fastening post;
107: mounting step;
108: stop portion;
201: housing;
202: clamping groove;
203: window;
204: crown tube;
205: button;
206: annular fastening groove;
207: adjustment rod;
301: locking loop;
302: locking tongue;
401: locking hole;
501: elastic plate;
502: protruding portion;
503: first inclined plate;
504: second inclined plate;
505: first connection plate;
506: second connection plate;
531: first groove;
532: second bump;
533: second foolproof groove;
541: first through hole;
542: fastening hole;
543: recessed portion;
544: bent portion;
545: slot;
551: second through hole;
552: first foolproof groove.

### DETAILED DESCRIPTION OF ILLUSTRATIVE EMBODIMENTS

To make the objectives, technical solutions, and advantages of embodiments of this application clearer, the following clearly and completely describes the technical solutions in embodiments of this application with reference to accompanying drawings in embodiments of this application. It is clear that the described embodiments are merely some rather than all of embodiments of this application. All other embodiments obtained by persons of ordinary skill in the art based on embodiments of this application without creative efforts shall fall within the protection scope of this application.

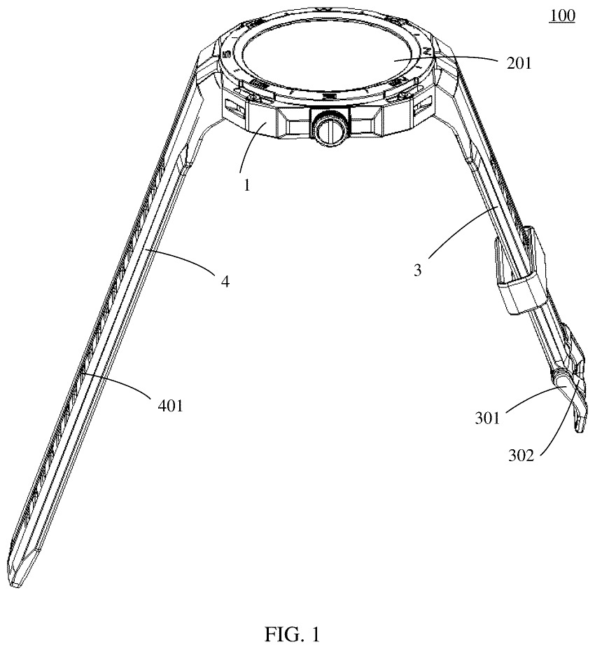

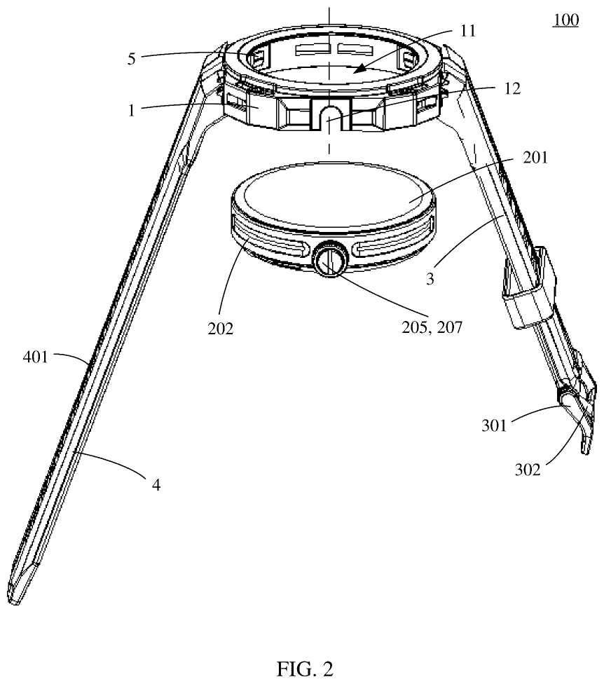

FIG. 1 is a diagram of assembly of a wearable device according to an embodiment of this application. As shown in FIG. 1, an embodiment of this application provides a wearable device 100. The wearable device 100 may be a device that can be worn on a human body and that is configured to perform timekeeping, such as a watch (namely, a wristwatch) or a pocket watch. Specifically, the wearable device 100 includes an outer frame 1 and a housing 201 mounted to the outer frame 1. FIG. 2 is an exploded view 1 of a wearable device according to an embodiment of this application. Refer to FIG. 2. The outer frame 1 is provided with a mounting channel 11, and the mounting channel 11 penetrates the outer frame 1. The housing 201 is disposed in the mounting channel 11. A movement (not shown) is disposed in the housing 201, and the movement is configured to perform timekeeping. A material of the outer frame 1 may include stainless steel, plastic, and the like. For example, a decorative coating may be formed on a surface of the outer frame 1 through a physical vapor deposition (physical vapor deposition, PVD for short) process, to improve abrasion resistance of the outer frame 1 and improve decoration effect of the outer frame 1.

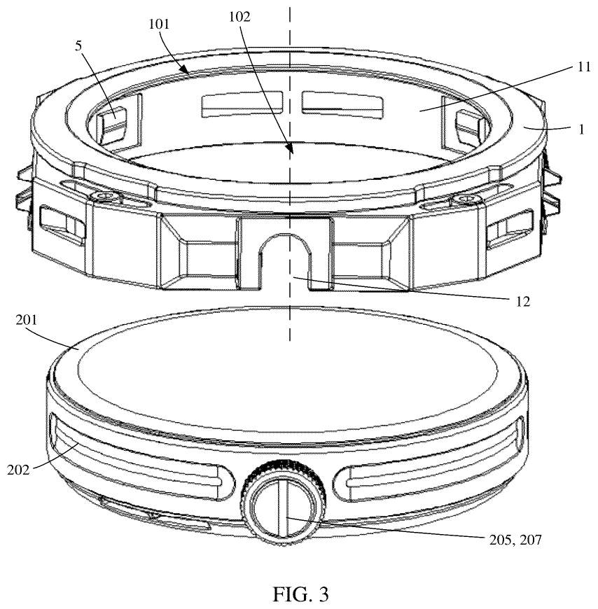

FIG. 3 is an exploded view 1 of an outer frame and a housing of a wearable device according to an embodiment of this application. Refer to FIG. 3. One end (a top end in a direction shown in FIG. 3) of the mounting channel 11 penetrates the outer frame 1, and an observation opening 101 is formed. Correspondingly, the other end (a bottom end in the direction shown in FIG. 3) of the mounting channel 11 penetrates the outer frame 1, to form a detachment opening 102. The housing 201 is mounted in the mounting channel 11 through the detachment opening 102. During use, a user may observe the housing 201 through the observation opening 101, to obtain information such as time on the movement.

Still refer to FIG. 2. The wearable device 100 may further include a first watch strap 3, a second watch strap 4, and a locking apparatus. An end of the first watch strap 3 is connected to the outer frame 1, an end of the second watch strap 4 is also connected to the outer frame 1, and the first watch strap 3 and the second watch strap 4 are disposed opposite to each other. In other words, the wearable device 100 may be a watch. The first watch strap 3 is connected to the second watch strap 4 by using the locking apparatus, so that the first watch strap 3, the second watch strap 4, and the outer frame 1 are arranged in an enclosing manner to form a wearing loop. The wearing loop surrounds a wrist of the user, to implement wearing of the wearable device 100.

In some implementations, the locking apparatus includes a locking loop 301 and a locking tongue 302. The locking loop 301 is disposed at an end that is of the first watch strap 3 and that is away from the outer frame 1, and an end of the locking tongue 302 is hinged to the locking loop 301. Correspondingly, the second watch strap 4 is provided with a plurality of locking holes 401 that are spaced from each other along an extension direction of the second watch strap 4. During wearing, the first watch strap 3 and the second watch strap 4 are wrapped around the wrist of the user. Then, an end that is of the second watch strap 4 and that is away from the outer frame 1 passes through the locking loop 301, and the locking tongue 302 is disposed to pass through one locking hole 401. In this way, the first watch strap 3 and the second watch strap 4 can be connected, to fasten the outer frame 1 to the wrist of the user and implement wearing. It may be understood that, the locking tongue 302 is fitted with different locking holes 401, to adjust a diameter of the wearing loop formed by arranging the first watch strap 3, the second watch strap 4, and the outer frame 1 in the enclosing manner. Therefore, adaptation to wrists of different sizes can be implemented, and wearing comfort of the user can be improved.

The first watch strap 3 and the second watch strap 4 may be rubber straps, or the first watch strap 3 and the second watch strap 4 may be metal straps formed by metal links that are sequentially connected. Certainly, in some implementations, the first watch strap 3 and the second watch strap 4 may alternatively be cloth straps woven from cotton threads or nylon threads. Materials of the first watch strap 3 and the second watch strap 4 are not limited in this embodiment.

In another implementation, the wearable device may further include a watch chain (not shown). One end of the watch chain may be connected to the outer frame 1 or the housing 201, and the other end of the watch strap may be connected to clothes of the user. Correspondingly, the outer frame 1 may be placed in a pocket of the clothes of the user, to implement wearing. In this case, the wearable device 100 is a pocket watch.

Still refer to FIG. 3. In this embodiment, the housing 201 is a sealed housing. In this case, the housing 201 can protect the movement against water and dust while fastening the movement. For example, the housing 201 may be in a cylindrical shape or a prism shape. A center line of the housing 201 and a center line (a dashed line in FIG. 3) of the mounting channel 11 may be collinear, so that the housing 201 can be located in the center of the mounting channel 11. This improves decoration effect of the wearable device 100.

For example, a material of the housing 201 may include stainless steel, plastic, or the like. In addition, a decorative coating may be formed on a surface of the housing 201 through a physical vapor deposition process, to improve abrasion resistance of the housing 201 and improve the decoration effect of the housing 201.

In the foregoing implementation, a cross-sectional shape of the housing 201 may be the same as a cross-sectional shape of the mounting channel 11. Cross-sectional dimensions of the housing 201 are properly set, so that the housing 201 can be attached to a side wall of the mounting channel 11, or there is a small distance between the housing 201 and the mounting channel 11. In this way, the decoration effect of the wearable device 100 can be further improved.

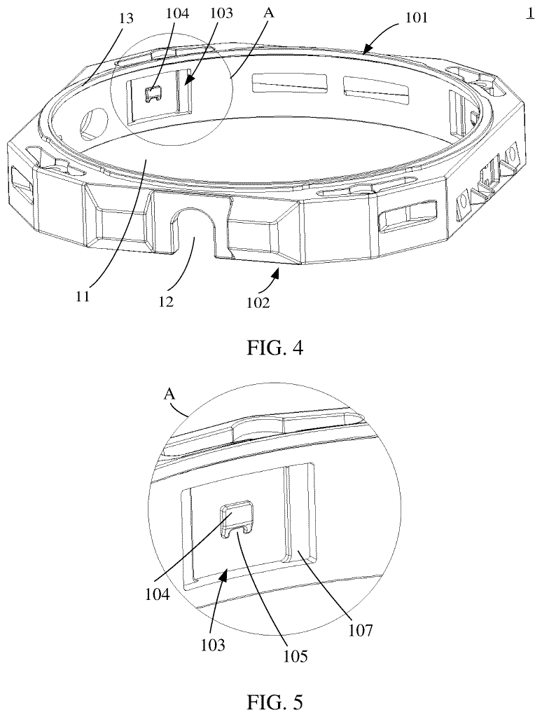

FIG. 4 is a schematic diagram of a structure of the outer frame in FIG. 3. Refer to FIG. 4. A stop flange 13 may be disposed at a position that is on the side wall of the mounting channel 11 and close to the observation opening 101. The stop flange 13 may abut against an end that is of the housing 201 and that faces the observation opening 101, to prevent the housing 201 from falling through the observation opening 101.

In this embodiment, the movement is configured to perform timekeeping. For example, the movement may be a mechanical movement, a quartz movement, a smart movement, or the like. This is not limited in this embodiment. The mechanical movement includes a watch face, a hand system, an escapement system, and a hairspring. The hairspring stores energy through elastic deformation of the hairspring. The hairspring is connected to the escapement system. The escapement system is drivingly connected to the hand system through gears. The escapement system receives a driving force from the hairspring, and drives a second hand, a minute hand, and an hour hand in the hand system to rotate. The second hand, the minute hand, and the hour hand are all disposed on the watch face. The quartz movement includes a watch face, a hand system, a battery, a quartz crystal oscillator, a motor, and a control circuit. The battery, the quartz crystal oscillator, and the motor are all electrically connected to the control circuit. The control circuit receives an oscillation signal sent by the quartz crystal oscillator, and forms, based on the oscillation signal, a drive signal for driving the motor to rotate. The motor drives, through gears, a second hand, a minute hand, and an hour hand in the hand system to rotate. The second hand, the minute hand, and the hour hand are all disposed on the watch face. The smart movement includes a mainboard, a battery, and a display panel. The mainboard is electrically connected to both the battery and the display panel. The mainboard is configured to control the display panel to display information such as a heart rate of the user and time.

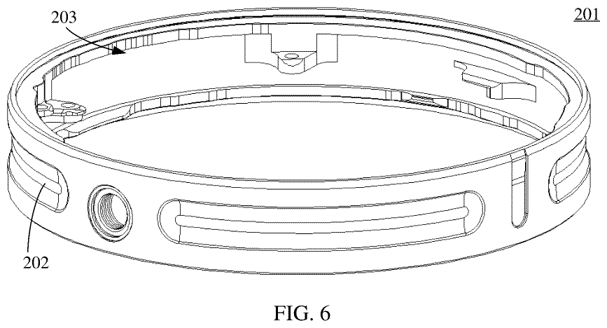

FIG. 6 is a schematic diagram of a structure of the housing in FIG. 3. Refer to FIG. 6. It may be understood that a window 203 may be provided at a position that is on the housing 201 and that faces the observation opening 101 shown in FIG. 3, and a transparent plate (not shown) covers the window 203 to seal the window 203. Correspondingly, the watch face or the display panel in the foregoing movement is disposed facing the window 203, so that the user can observe the watch face or the display panel through the window 203 to obtain time information.

Still refer to FIG. 3. In an implementation in which the movement is the mechanical movement and the quartz movement, a crown tube that communicates with internal space of the housing 201 is disposed on the housing 201. An adjustment rod 207 is disposed to pass through the crown tube. The adjustment rod 207 is connected to the movement. In this case, the adjustment rod 207 is twisted to drive the minute hand to rotate, so that time calibration of the movement is implemented. Correspondingly, a matching groove 12 is provided at an end that is of the outer frame 1 and that is away from the observation opening 101. The matching groove 12 penetrates the outer frame 1 along a direction perpendicular to the center line (the dashed line in FIG. 3) of the mounting channel 11. When the housing 201 is mounted in the mounting channel 11, the crown tube and the adjustment rod 207 are clamped in the matching groove 12. The crown tube is clamped in the matching groove 12, so that positions of the housing 201 and the outer frame 1 can be limited, and the housing 201 can be prevented from rotating in the mounting channel 11.

In an implementation in which the movement is the smart movement, a crown tube that communicates with internal space of the housing 201 is disposed on the housing 201. A button 205 is disposed in the crown tube. The button 205 is electrically connected to the mainboard, so that the smart movement can be controlled by using the button 205. Correspondingly, a matching groove 12 is provided at an end that is of the outer frame 1 and that is away from the observation opening 101. The matching groove 12 penetrates the outer frame 1 along a direction perpendicular to the center line of the mounting channel 11. When the housing 201 is mounted in the mounting channel 11, the crown tube and the button 205 are clamped in the matching groove 12. The crown tube is clamped in the matching groove 12, so that positions of the housing 201 and the outer frame 1 can be limited, and the housing 201 can be prevented from rotating in the mounting channel 11.

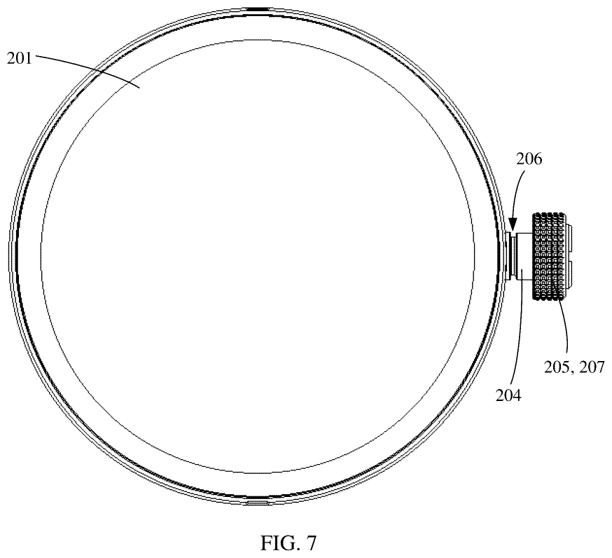

FIG. 7 is a schematic diagram of a structure of a housing of a wearable device according to an embodiment of this application. As shown in FIG. 7, an annular fastening groove 206 may be provided on a side wall of the crown tube 204, a fastening ring is disposed at an end of the watch chain, and the fastening ring is clamped in the annular fastening groove 206, to connect the watch chain and the crown tube 204. In this case, the wearable device 100 may be a pocket watch.

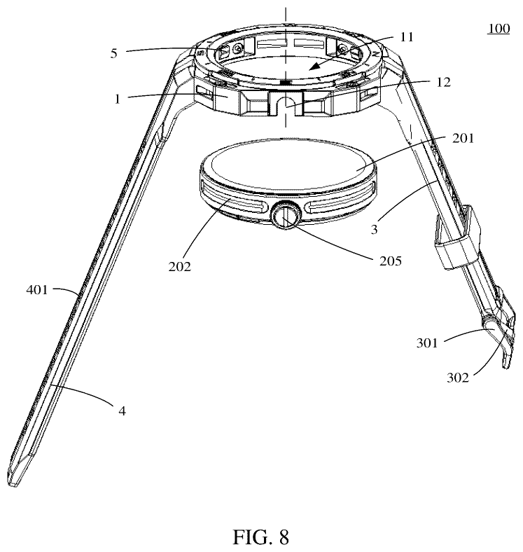

FIG. 8 is an exploded view 2 of a wearable device according to an embodiment of this application. Refer to FIG. 8. In this embodiment, the housing 201 is disposed in the mounting channel 11, and the housing 201 is detachably connected to the outer frame 1. For example, the wearable device 100 further includes a clamping component 5. The clamping component 5 is disposed between the outer frame 1 and the housing 201, and the outer frame 1 is clamped to the housing 201 by using the clamping component 5. Based on the foregoing disposition, the outer frame 1 is clamped to the housing 201 by using the clamping component 5. This facilitates detachment of the housing 201 from the outer frame 1 and mounting of the housing 201 to the outer frame 1.

Certainly, in another implementation, the outer frame 1 may be further connected to the housing 201 in a detachable manner such as a bolt connection. A detachable connection manner between the outer frame 1 and the housing 201 is not limited in this embodiment.

According to the wearable device 100 provided in this embodiment, the outer frame 1 is provided with the mounting channel 11, and the mounting channel 11 penetrates the outer frame 1. The housing 201 is disposed in the mounting channel 11, and the housing 201 is detachably connected to the outer frame 1. The movement is disposed in the housing 201, and the movement is configured to perform timekeeping. When the outer frame 1 is damaged, because each part of the movement is disposed in the housing 201, the housing 201 can be detached from the outer frame 1 and mounted to a new outer frame 1 without disassembling the movement. This reduces difficulty in repairing the wearable device 100.

In addition, there may be a plurality of types of outer frames 1. At least one of external structures, materials, or colors of different types of outer frames 1 is different. In this way, the user can mount the housing 201 on different types of outer frames 1, to form the wearable device 100 having different appearances. This increases selectivity of the user, meets a personalized requirement of the user, and further improves user experience.

In some embodiments, still refer to FIG. 8. For example, the outer frame 1 may be connected to the first watch strap 3 and the second watch strap 4. The user can mount the housing 201 on the outer frame 1, so that the wearable device 100 is a watch. For another example, the outer frame 1 is not connected to the first watch strap 3 and the second watch strap 4. In this case, after mounting the housing 201 on the outer frame 1, the user can mount an end of the watch chain on the outer frame 1 or the housing 201, so that the wearable device 100 is a pocket watch. In this way, selectivity of the user is also increased, and user experience is improved.

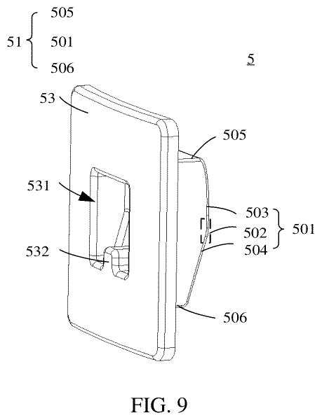

FIG. 9 is a schematic diagram of a structure of a clamping component in FIG. 3. Refer to FIG. 9. In some embodiments, the clamping component 5 includes a clamping portion 51 disposed on the side wall of the mounting channel 11. A clamping groove 202 shown in FIG. 3 is provided on a side wall of the housing 201. The clamping portion 51 is clamped in the clamping groove 202, to detachably connect the housing 201 and the outer frame 1. Based on the foregoing disposition, the clamping component 5 has a simple structure and is easy to manufacture. It may be understood that there may be a plurality of clamping portions 51, and the plurality of clamping portions 51 are disposed at intervals around the center line of the mounting channel 11. Correspondingly, there are also a plurality of clamping grooves 202, and the plurality of clamping grooves 202 are disposed at intervals around the center line of the mounting channel 11. Each clamping portion 51 is clamped to one clamping groove 202, so that a connection force between the housing 201 and the outer frame 1 can be improved.

Still refer to FIG. 9. The clamping portion 51 may include an elastic plate 501. The elastic plate 501 is disposed on the side wall of the mounting channel 11. A protruding portion 502 is provided on a surface that is of the elastic plate 501 and that faces the center line of the mounting channel 11. The protruding portion 502 is clamped in the clamping groove 202. The elastic plate 501 has a specific elastic force. Under the action of the elastic force, the elastic plate 501 is always clamped in the clamping groove 202. This prevents the clamping portion 51 and the clamping groove 202 from being separated during use. The clamping portion 51 has a simple structure and is easy to manufacture.

For example, an end that is of the elastic plate 501 and that faces the detachment opening 102 shown in FIG. 3 may be connected to the side wall of the mounting channel 11, and the elastic plate 501 may be disposed in an inclined manner relative to the center line of the mounting channel 11. In other words, an end that is of the elastic plate 501 and that faces the observation opening 101 is closer to the center line of the mounting channel 11 than the end that is of the elastic plate 501 and that faces the detachment opening 102. In a process in which the housing 201 is mounted in the mounting channel 11 through the detachment opening 102, a side wall that is of the housing 201 and that faces the mounting channel 11 abuts against the elastic plate 501, so that the elastic plate 501 is elastically deformed. Under the action of the elastic force of the elastic plate 501, the protruding portion 502 on the elastic plate 501 is clamped in the clamping groove 202, to connect the housing 201 and the outer frame 1. It may be understood that the protruding portion 502 may be the end that is of the elastic plate 501 and that faces the observation opening 101. Certainly, the protruding portion 502 may alternatively be a block fastened to the elastic plate 501 in a manner such as welding or bolt connection. This is not limited in this embodiment, provided that the protruding portion 502 can be clamped in the clamping groove 202, to prevent the housing 201 and the outer frame 1 from being separated.

Still refer to FIG. 9. In some implementations, two ends of the elastic plate 501 in a direction parallel to the center line (the dashed line in FIG. 3) of the mounting channel 11 shown in FIG. 3 may be connected to the side wall of the mounting channel 11, to improve a connection force between the elastic plate 501 and the outer frame 1. This prevents the elastic plate 501 from falling. Correspondingly, the clamping portion 51 may further include a first connection plate 505 and a second connection plate 506. Both the first connection plate 505 and the second connection plate 506 are perpendicular to the center line of the mounting channel 11, and the first connection plate 505 and the second connection plate 506 are disposed at an interval along a direction parallel to the center line of the mounting channel 11. One end of the first connection plate 505 is connected to the side wall of the mounting channel 11, and the other end of the first connection plate 505 is connected to one end of the elastic plate 501 (the end that is of the elastic plate 501 and that faces the observation opening 101). One end of the second connection plate 506 is connected to the side wall of the mounting channel 11, and the other end of the second connection plate 506 is connected to the other end of the elastic plate 501 (the end that is of the elastic plate 501 and that faces the detachment opening 102). A direction shown in FIG. 9 is used as an example. The elastic plate 501 is disposed between the first connection plate 505 and the second connection plate 506. A top end of the elastic plate 501 is connected to the first connection plate 505, and a bottom end of the elastic plate 501 is connected to the second connection plate 506, so that the elastic plate 501 is fastened to the side wall of the mounting channel 11 by using the first connection plate 505 and the second connection plate 506.

It may be understood that the elastic plate 501, the first connection plate 505, and the second connection plate 506 may be an integrated structure. The integrated structure is formed through a process such as bending, injection molding, or casting, so that the elastic plate 501 does not need to be mounted on the first connection plate 505 and the second connection plate 506 again. This simplifies manufacturing difficulty. In addition, the first connection plate 505 and the second connection plate 506 are also elastic, so that a clamping force for the protruding portion 502 to be clamped in the clamping groove 202 can be improved, to further prevent the protruding portion 502 and the clamping groove 202 from being separated. Certainly, in another implementation, the elastic plate 501 may alternatively be connected to the first connection plate 505 and the second connection plate 506 in a manner such as welding or bolt connection. This is not limited in this embodiment.

In this embodiment, the elastic plate 501 may be a thermoplastic polyurethane (thermoplastic polyurethanes, TPU for short) elastomer plate. The elastic plate 501 made of TPU has high strength, toughness, abrasion resistance, oil resistance, and the like, and can prevent the housing 201 from being scratched while ensuring sufficient elasticity, to improve a service life of the wearable device 100. It may be understood that, in an implementation in which the elastic plate 501, the first connection plate 505, and the second connection plate 506 are of an integrated structure, the elastic plate 501, the first connection plate 505, and the second connection plate 506 are all made of the TPU. Correspondingly, the elastic plate 501, the first connection plate 505, and the second connection plate 506 may be formed through an injection molding process or a heat bending process, to reduce difficulty in manufacturing the wearable device 100 shown in FIG. 2. Certainly, in another implementation, the elastic plate 501 may be a steel plate, a copper plate, or the like that is elastic. A material of the elastic plate 501 is not limited in this embodiment.

Still refer to FIG. 9. In the foregoing implementation, the elastic plate 501 includes a first inclined plate 503 and a second inclined plate 504 that are sequentially disposed along a direction of the center line of the mounting channel 11 shown in FIG. 3. An end that is of the first inclined plate 503 and that faces the second inclined plate 504 is connected to the second inclined plate 504. The first inclined plate 503 is disposed in an inclined manner relative to the center line of the mounting channel 11. In this way, an end that is of the first inclined plate 503 and that is away from the second inclined plate 504 is farther away from the center line of the mounting channel 11 than the end that is of the first inclined plate 503 and that faces the second inclined plate 504. Similarly, the second inclined plate 504 is disposed in an inclined manner relative to the center line of the mounting channel 11. In this way, an end that is of the second inclined plate 504 and that is away from the first inclined plate 503 is farther away from the center line of the mounting channel 11 than an end that is of the second inclined plate 504 and that faces the first inclined plate 503. The direction shown in FIG. 9 is used as an example. A bottom end of the first inclined plate 503 is connected to a top end of the second inclined plate 504. A top end of the first inclined plate 503 is farther away from the center line of the mounting channel 11 than the bottom end of the first inclined plate 503, and a bottom end of the second inclined plate 504 is farther away from the center line of the mounting channel 11 than the top end of the second inclined plate 504.

It may be understood that both the first inclined plate 503 and the second inclined plate 504 are disposed in an inclined manner relative to the center line of the mounting channel 11. In this way, the protruding portion 502 protruding from the center line of the mounting channel 11 is formed at a joint between the first inclined plate 503 and the second inclined plate 504, and the protruding portion 502 is clamped in the clamping groove 202 on the housing 201, to connect the outer frame 1 and the housing 201.

Based on the foregoing disposition, in a process of mounting the housing 201 in the mounting channel 11, the side wall that is of the housing 201 and that faces the mounting channel 11 is first in contact with the second inclined plate 504, and the second inclined plate 504 may guide the housing 201 to move in the mounting channel 11. In addition, in a moving process of the mounting channel 11, the second inclined plate 504 and the first inclined plate 503 are gradually compressed and elastically deformed, to generate elastic forces. When the housing 201 moves to a junction (namely, the protruding portion 502) of the first inclined plate 503 and the second inclined plate 504 and is clamped in the clamping groove 202, under the action of the elastic forces of the first inclined plate 503 and the second inclined plate 504, the junction of the first inclined plate 503 and the second inclined plate 504 is always clamped in the clamping groove 202, to connect the housing 201 and the outer frame 1. Both the first inclined plate 503 and the second inclined plate 504 are elastically deformed, so that an elastic force of the elastic plate 501 can be improved. This improves a connection force between the housing 201 and the outer frame 1. When detaching the housing 201, the user may press the housing 201 from the observation opening 101 to the detachment opening 102, so that the junction of the first inclined plate 503 and the second inclined plate 504 gradually detaches from the clamping groove 202. After detachment, the housing 201 gradually detaches from the mounting channel 11 under guidance of the second inclined plate 504.

In an implementation in which the clamping portion 51 includes the first connection plate 505 and the second connection plate 506, the end that is of the first inclined plate 503 and that is away from the second inclined plate 504 is connected to the first connection plate 505, and the end that is of the second inclined plate 504 and that is away from the first inclined plate 503 is connected to the second connection plate 506, to fasten the first inclined plate 503 and the second inclined plate 504.

Still refer to FIG. 9. In some embodiments, the clamping component 5 shown in FIG. 3 further includes an adapter plate 53. The elastic plate 501 is disposed on the adapter plate 53. The adapter plate 53 is connected to the side wall of the mounting channel 11. The elastic plate 501 is connected to the side wall of the mounting channel 11 by using the adapter plate 53. This facilitates mounting of the elastic plate 501.

In an implementation in which the clamping portion 51 includes the first connection plate 505 and the second connection plate 506, an end that is of the first connection plate 505 and that is away from the elastic plate 501 and an end that is of the second connection plate 506 and that is away from the elastic plate 501 are both connected to a surface that is of the adapter plate 53 and that faces the center line of the mounting channel 11 shown in FIG. 3, to fasten the first connection plate 505 and the second connection plate 506 to the adapter plate 53. For example, the end that is of the first connection plate 505 and that is away from the elastic plate 501 and the end that is of the second connection plate 506 and that is away from the elastic plate 501 may be connected to the adapter plate 53 in a manner such as welding or bolt connection. Certainly, the end that is of the first connection plate 505 and that is away from the elastic plate 501 and the end that is of the second connection plate 506 and that is away from the elastic plate 501 may alternatively be connected to the adapter plate 53 by using an adhesive. A connection manner between the first connection plate 505 and a second fastening table and the elastic plate 501 is not limited in this embodiment, provided that the first connection plate 505 and the second connection plate 506 can be fastened to the elastic plate 501.

Refer to FIG. 4 and FIG. 5. FIG. 5 is a partial enlargement diagram of A in FIG. 4. A mounting groove 103 is provided on the side wall of the mounting channel 11, and the adapter plate 53 shown in FIG. 9 is mounted in the mounting groove 103. Based on the foregoing disposition, the adapter plate 53 can be prevented from protruding from the side wall of the mounting channel 11. This prevents the elastic plate 501 from extending to the center line of the mounting channel 11 for an excessively large distance, reduces a gap between the housing 201 and the side wall of the mounting channel 11, and improves decoration effect of the wearable device 100.

Still refer to FIG. 5. In the foregoing implementation, a groove bottom of the mounting groove 103 is provided with a first bump 104. A first groove 531 is provided on a surface that is of the adapter plate 53 and that faces the groove bottom shown in FIG. 9. The first bump 104 is clamped in the first groove 531. The groove bottom of the mounting groove 103 is a side wall that is of the mounting groove 103 and that is away from the center line of the mounting channel 11. The first bump 104 may be in a regular shape such as a cylindrical shape or a prism shape. Certainly, the first bump 104 may alternatively be in another irregular shape. In an implementation in which the first bump 104 is in a cylindrical shape or a prism shape, a center line of the first bump 104 may be perpendicular to the center line of the mounting channel 11.

Based on the foregoing disposition, the first bump 104 is clamped in the first groove 531, so that positions of the adapter plate 53 and the outer frame 1 can be determined, and the adapter plate 53 can also be prevented from shaking in the mounting groove 103 during use.

Still refer to FIG. 5. The first bump 104 is provided with a second groove 105. A depth direction of the second groove 105 is parallel to the center line of the mounting channel 11. The second groove 105 may be disposed on a side surface that is of the first bump 104 and that faces the observation opening 101. Certainly, the second groove 105 may alternatively be disposed on a side surface that is of the first bump 104 and that faces the detachment opening 102. Correspondingly, a second bump 532 is provided on a groove wall that is of the first groove 531 shown in FIG. 9 and that is adjacent to the groove bottom. When the adapter plate 53 is mounted in the mounting groove 103, the first bump 104 is clamped in the first groove 531. In addition, the second bump 532 is clamped in the second groove 105. Based on the foregoing disposition, position precision of the adapter plate 53 and position precision of the outer frame 1 are improved, and the adapter plate 53 can be further prevented from shaking in the mounting groove 103 during use. In an implementation in which the first bump 104 is in a cylindrical shape, the second bump is clamped in the second groove 105, so that foolproof between the adapter plate 53 and the outer frame 1 can be further implemented.

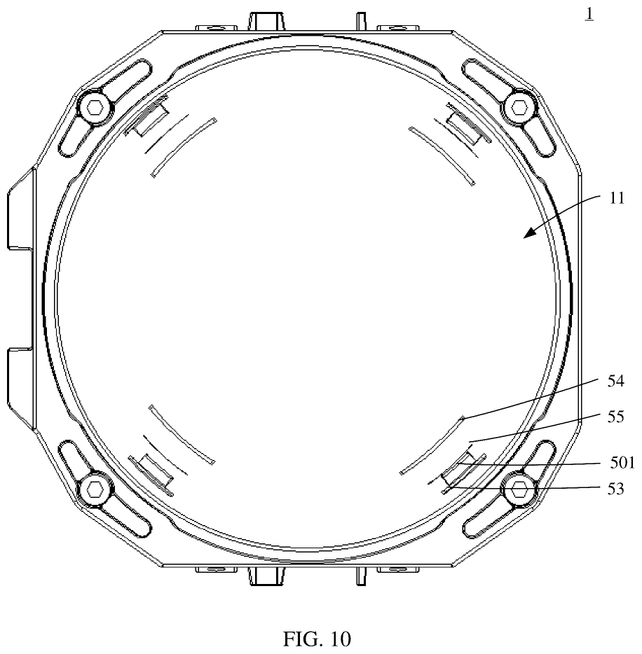

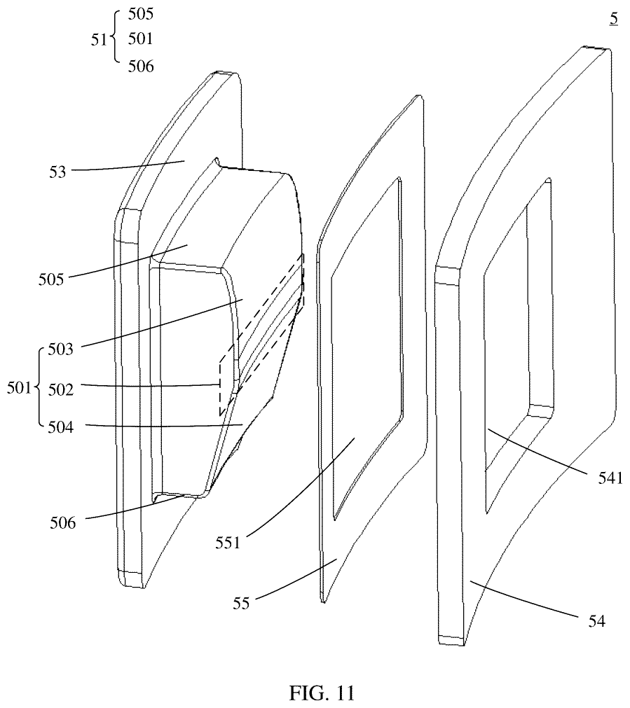

FIG. 10 is an exploded view 1 of a clamping component and an outer frame of a wearable device according to an embodiment of this application. FIG. 11 is an exploded view of the clamping component, a bonding layer, and a fastening plate in FIG. 10. Refer to FIG. 10 and FIG. 11. In this embodiment, the wearable device 100 shown in FIG. 2 further includes a fastening plate 54. The fastening plate 54 covers a surface that is of the adapter plate 53 and that is away from the side wall of the mounting channel 11. In other words, the fastening plate 54 covers a surface that is of the adapter plate 53 and that faces the center line of the mounting channel 11. The fastening plate 54 is provided with a first through hole 541. The elastic plate 501 extends out of the first through hole 541. The fastening plate 54 is connected to the outer frame 1. The adapter plate 53 is fastened to the outer frame 1 by using the fastening plate 54, to fasten the elastic plate 501.

It may be understood that, in an implementation in which the mounting groove 103 shown in FIG. 5 is provided on the side wall of the mounting channel 11, both the adapter plate 53 and the fastening plate 54 may be accommodated in the mounting groove 103, to prevent an excessively large distance between the housing 201 and the mounting channel 11. This improves the decoration effect of the wearable device 100.

A connection manner between the fastening plate 54 and the outer frame 1 is not limited in this embodiment, provided that the fastening plate 54 can be fastened to the outer frame 1. In some embodiments, both the fastening plate 54 and the outer frame 1 may be made of metal such as stainless steel or copper. Correspondingly, the fastening plate 54 may be connected to the outer frame 1 in a welding manner. For example, a mounting step 107 shown in FIG. 5 may be disposed in the mounting groove 103. When the fastening plate 54 is mounted in the mounting groove 103, the fastening plate 54 is attached to the mounting step 107, and then the fastening plate 54 is welded to the mounting step 107 in a laser welding or pressure welding manner.

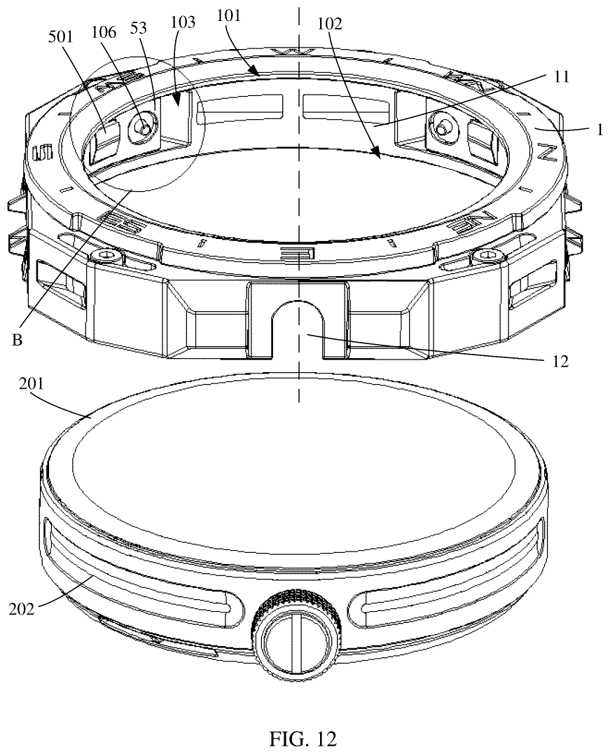

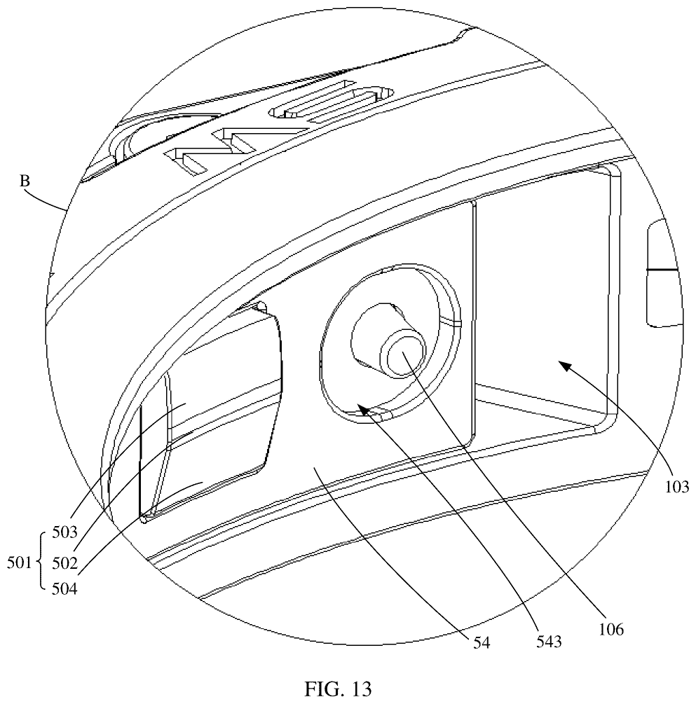

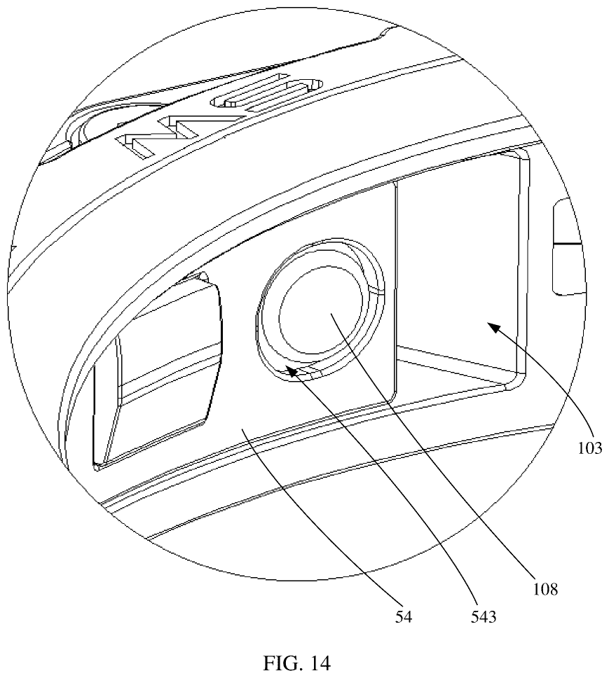

FIG. 12 is an exploded view 2 of an outer frame and a housing of a wearable device according to an embodiment of this application. FIG. 13 is a partial enlargement view of B in FIG. 12. Refer to FIG. 12 and FIG. 13. Certainly, in this embodiment, both the outer frame 1 and the fastening plate 54 may be made of plastic. Correspondingly, the groove bottom of the mounting groove 103 is provided with a fastening post 106. The fastening plate 54 is provided with a fastening hole 542. The fastening post 106 is disposed to pass through the fastening hole 542. A stop portion 108 shown in FIG. 14 (FIG. 14 is a schematic diagram of a structure, in which a stop portion abuts against a fastening plate, that is of a wearable device according to an embodiment of this application) is provided at an end that is of a fastening portion and that is away from the mounting channel 11. The stop portion 108 abuts against a surface that is of the fastening plate 54 and that faces the center line of the mounting channel 11. In this way, the stop portion 108 can prevent the fastening plate 54 and the fastening post 106 from being separated, so that the fastening plate 54 is fastened.

Still refer to FIG. 14. In the foregoing implementation, the stop portion 108 may be a nail cap formed by melting an end that is of the fastening portion and that is close to the center line of the mounting channel 11. In this case, after the fastening plate 54 is placed in the mounting channel 11, the fastening post 106 is disposed to pass through the fastening hole 542, and then the nail cap is formed in a hot melting manner, so that the fastening plate 54 can be fastened. This simplifies a structure of the wearable device 100 shown in FIG. 8, and facilitates mounting of the fastening plate 54. Certainly, the stop portion 108 may alternatively be a nut (not shown) disposed on the fastening post 106. Correspondingly, the fastening post 106 is provided with an external thread. After the fastening plate 54 is placed in the mounting channel 11, the fastening post 106 is disposed to pass through the fastening hole 542, and then the nut is fitted with the external thread on the fastening post 106, so that the fastening plate 54 can also be fastened.

Still refer to FIG. 14. It may be understood that a recessed portion 543 may be provided on the surface that is of the fastening plate 54 and that faces the center line of the mounting channel 11, and the stop portion 108 is accommodated in the recessed portion 543. In this way, the stop portion 108 can be prevented from protruding into the mounting channel 11. This reduces a distance between the housing 201 and the side wall of the mounting channel 11, and improves the decoration effect of the wearable device 100.

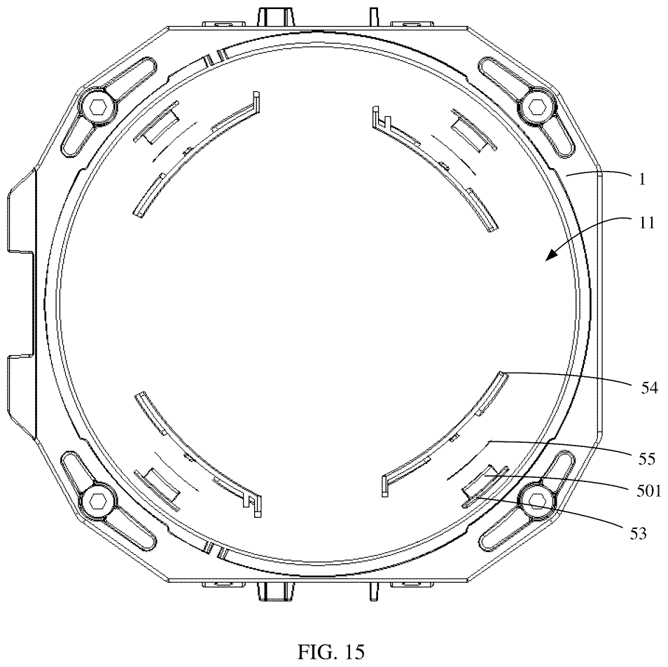

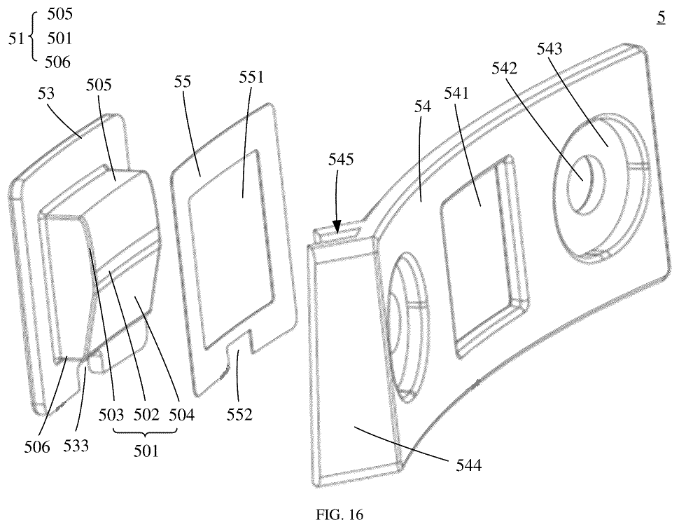

FIG. 15 is an exploded view 2 of a clamping component and an outer frame of a wearable device according to an embodiment of this application. FIG. 16 is an exploded view of the clamping component, a bonding layer, and a fastening plate in FIG. 15. Refer to FIG. 15 and FIG. 16. The wearable device 100 shown in FIG. 7 further includes a bonding layer 55. The bonding layer 55 is disposed between the fastening plate 54 and the adapter plate 53. The bonding layer 55 is bonded to both the fastening plate 54 and the adapter plate 53. Based on the foregoing disposition, a connection force between the adapter plate 53 and the fastening plate 54 can be improved, to further prevent the adapter plate 53 from shaking in the mounting groove 103 during use. For example, the bonding layer 55 may be a hot melt adhesive. Correspondingly, after the bonding layer 55 is clamped between the fastening plate 54 and the adapter plate 53, the bonding layer 55 may be bonded to both the fastening plate 54 and the adapter plate 53 through heating. Certainly, the bonding layer 55 may alternatively be a double-sided adhesive. Correspondingly, when the bonding layer 55 is clamped between the fastening plate 54 and the adapter plate 53, the bonding layer 55 may be bonded to both the fastening plate 54 and the adapter plate 53.

Still refer to FIG. 16, the bonding layer 55 is provided with a second through hole 551. The elastic plate 501 extends out of the second through hole 551. An edge of the bonding layer 55 is provided with a first foolproof groove 552. An end of the adapter plate 53 is provided with a second foolproof groove 533. Projections of the first foolproof groove 552 and the second foolproof groove 533 on the side wall of the mounting channel 11 overlap. Based on the foregoing disposition, foolproof between the bonding layer 55 and the adapter plate 53 can be implemented by using the first foolproof groove 552 and the second foolproof groove 533. This facilitates mounting of the bonding layer 55.

In some implementations, an end of the fastening plate 54 may be provided with a bent portion 544. A slot 545 is provided on the bent portion 544. Correspondingly, a plug-in portion (not shown) is provided in the mounting groove 103 shown in FIG. 12. When the fastening plate 54 is mounted in the mounting groove 103, the plug-in portion is inserted into the slot 545, to further fasten the fastening plate 54 to the outer frame 1. In addition, phase positions of the fastening plate 54 and the outer frame 1 can be further limited, to improve position precision of the fastening plate 54.

In this embodiment, the clamping portion 51 may alternatively be disposed on the housing 201. Correspondingly, a clamping groove 202 is provided on the side wall of the mounting channel 11. The clamping portion 51 is clamped to the clamping groove 202, so that the housing 201 can be detachably connected to the outer frame 1.

It should be noted that, in the descriptions of embodiments of this application, unless otherwise specified and limited, the terms “interconnect” and “connection” should be understood in a broad sense. For example, the connection may be a fixed connection, or an integrated connection, or may be a mechanical connection, or may be an electrical connection, or may be a direct connection, or may be an indirect connection by using an intermediate medium, or may be an internal connection between two components. Persons skilled in the art may understand specific meanings of the terms in embodiments of this application based on specific situations.

Finally, it should be noted that the foregoing embodiments are merely intended for describing the technical solutions of embodiments of this application other than limiting this application. Although this application is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of embodiments of this application.

1. A wearable device, comprising:
an outer frame, wherein a mounting channel penetrates the outer frame;
a housing, wherein the housing is disposed in the mounting channel, and the housing is detachably connected to the outer frame;
a movement, wherein the movement is disposed in the housing;
a clamping component, wherein the clamping component is disposed between the outer frame and the housing, and the outer frame is clamped to the housing by using the clamping component;
wherein the clamping component comprises a clamping portion disposed on a side wall of the mounting channel, a clamping groove extends in a side wall of the housing, and the clamping portion is clamped in the clamping groove,
wherein the clamping portion comprises an elastic plate, the elastic plate is disposed on the side wall of the mounting channel, a protruding portion is provided on a surface that is of the elastic plate and that faces a center line of the mounting channel, and the protruding portion is clamped in the clamping groove.

2-4. (canceled)

5. The wearable device according to claim 1, wherein the clamping portion further comprises:
a first connection plate, wherein a first end of the first connection plate is connected to the side wall of the mounting channel, and a second end of the first connection plate is connected to a first end of the elastic plate; and
a second connection plate, wherein a first end of the second connection plate is connected to the side wall of the mounting channel, and a second end of the second connection plate is connected to a second end of the elastic plate.

6. The wearable device according to claim 5, wherein the first connection plate, the second connection plate, and the elastic plate are of an integrated structure.

7. The wearable device according to claim 1, wherein the elastic plate is a thermoplastic polyurethane elastomer plate.

8. The wearable device according to claim 1, wherein the elastic plate comprises:
a first inclined plate and a second inclined plate that are sequentially disposed along a direction of the center line of the mounting channel, wherein a first end of the first inclined plate faces the second inclined plate and is connected to the second inclined plate, a second end of the first inclined plate is farther away from the second inclined plate than the first end of the first inclined plate, the second end of the first inclined plate is farther away from the center line of the mounting channel than the first end of the first inclined plate, and a first end of the second inclined plate is farther away from the first inclined plate than a second end of the second inclined plate that faces the first inclined plate, and the first end of the second inclined plate is farther away from the center line of the mounting channel than the second end of the second inclined plate that faces the first inclined plate; and
the protruding portion is formed at a joint between the first inclined plate and the second inclined plate.

9. The wearable device according to claim 1, wherein the clamping component further comprises an adapter plate, the elastic plate is disposed on the adapter plate, and the adapter plate is connected to the side wall of the mounting channel.

10. The wearable device according to claim 9, wherein a mounting groove extends in the side wall of the mounting channel, and the adapter plate is mounted in the mounting groove.

11. The wearable device according to claim 10, wherein a first bump is on a groove bottom of the mounting groove, a first groove extends in a surface that is of the adapter plate and that faces the groove bottom, and the first bump is clamped in the first groove.

12. The wearable device according to claim 11, wherein a second groove extends in the first bump, a second bump is on a side wall of the first groove, and the second bump is clamped in the second groove.

13. The wearable device according to claim 11, wherein the wearable device further comprises a fastening plate, a first through hole extends in the fastening plate, the fastening plate covers a surface that is of the adapter plate and that faces the center line of the mounting channel, the elastic plate extends out of the first through hole, and the fastening plate is connected to the outer frame.

14. The wearable device according to claim 13, wherein the wearable device further comprises a bonding layer, the bonding layer is disposed between the fastening plate and the adapter plate, and the bonding layer is bonded to both the fastening plate and the adapter plate.

15. The wearable device according to claim 14, wherein a second through hole extends in the bonding layer, the elastic plate extends out of the second through hole, a first foolproof groove extends in an edge of the bonding layer, a second foolproof groove extends in an end of the adapter plate, and projections of the first foolproof groove and the second foolproof groove on the side wall of the mounting channel overlap.

16. The wearable device according to claim 13, wherein a fastening hole extends in the fastening plate, a fastening post extends in the groove bottom of the mounting groove, the fastening post is disposed to pass through the fastening hole, a stop portion is provided at an end that is of the fastening post and that faces the center line of the mounting channel, and the stop portion abuts against a surface that is of the fastening plate and that faces the center line of the mounting channel.

17. The wearable device according to claim 13, wherein the fastening plate is accommodated in the mounting groove.

18. The wearable device according to claim 1, wherein a crown tube is disposed on the housing, a matching groove extends in an end of the outer frame along the direction of the center line of the mounting channel, the matching groove penetrates the outer frame along a direction perpendicular to the center line of the mounting channel, and the crown tube is clamped in the matching groove.

19. The wearable device according to claim 5, wherein the elastic plate comprises:
a first inclined plate and a second inclined plate that are sequentially disposed along a direction of the center line of the mounting channel, wherein a first end of the first inclined plate faces the second inclined plate and is connected to the second inclined plate, a second end of the first inclined plate is farther away from the second inclined plate than the first end of the first inclined plate, the second end of the first inclined plate is farther away from the center line of the mounting channel than the first end of the first inclined plate, and a first end of the second inclined plate is farther away from the first inclined plate than a second end of the second inclined plate that faces the first inclined plate, and the first end of the second inclined plate is farther away from the center line of the mounting channel than the second end of the second inclined plate that faces the first inclined plate; and
the protruding portion is formed at a joint between the first inclined plate and the second inclined plate.

20. The wearable device according to claim 6, wherein the elastic plate comprises:
a first inclined plate and a second inclined plate that are sequentially disposed along a direction of the center line of the mounting channel, wherein a first end of the first inclined plate faces the second inclined plate and is connected to the second inclined plate, a second end of the first inclined plate is farther away from the second inclined plate than the first end of the first inclined plate, the second end of the first inclined plate is farther away from the center line of the mounting channel than the first end of the first inclined plate, and a first end of the second inclined plate is farther away from the first inclined plate than a second end of the second inclined plate that faces the first inclined plate, and the first end of the second inclined plate is farther away from the center line of the mounting channel than the second end of the second inclined plate that faces the first inclined plate; and
the protruding portion is formed at a joint between the first inclined plate and the second inclined plate.

21. The wearable device according to claim 5, wherein the clamping component further comprises an adapter plate, the elastic plate is disposed on the adapter plate, and the adapter plate is connected to the side wall of the mounting channel.

22. The wearable device according to claim 19, wherein the clamping component further comprises an adapter plate, the elastic plate is disposed on the adapter plate, and the adapter plate is connected to the side wall of the mounting channel.

23. The wearable device according to claim 20, wherein the clamping component further comprises an adapter plate, the elastic plate is disposed on the adapter plate, and the adapter plate is connected to the side wall of the mounting channel.
